(19) United States
(12) Patent Application Publication
(10) Pub. No.: US 2017/0188573 A1
(43) Pub. Date: Jul. 6, 2017

(54) METHOD FOR IMPROVING THE QUALITY OF MAMMALIAN SPERMATOZOA

(71) Applicant: INSTRUMENTS UTILS DE LABORATORI GENIUL, SL, Terrassa Barcelona (ES)

(72) Inventors: Francesc CODONY IGLESIAS, Mataro (Barcelona) (ES); Juan Enrique RODRÍGUEZ GIL, Artes (Barcelona) (ES)

(73) Assignee: INSTRUMENTS UTILS DE LABORATORI GENIUL, SL, Terrassa Barcelona (ES)

(21) Appl. No.: 15/461,712

(22) Filed: Mar. 17, 2017

Related U.S. Application Data
(63) Continuation of application No. PCT/IB2015/001635, filed on Sep. 17, 2015.

(30) Foreign Application Priority Data
Sep. 19, 2014 (EP) 14380026.6

(51) Int. Cl. A01N 1/02

(52) U.S. Cl. CPC A01N 1/0294

(57) ABSTRACT

A method for increasing the fertilizing capacity of sperm cells, which method includes irradiating sperm cells with non-coherent red light in a discontinuous manner according to a pattern that includes at least one sequence of two irradiation periods of specific durations, which are separated by an intermediate period of darkness of a specific duration. Each of the specific periods of irradiation and darkness lasts between 8 and 15 minutes.

### FIELD OF THE ART

The present invention relates to a methodology for the treatment of mammalian seminal fluids which is not based on chemical reagents and has the objective of increasing fertility of the seminal fluid by means of, but not limited to, activating the motility of the spermatozoa contained in said fluid, their resistance to stress and generally improving spermatozoa viability.

This methodology is based on treatment by means of exposing a vessel containing the seminal fluid to an electromagnetic (visible light) radiation. The treatment conditions have been optimized to specific wavelength, time and dose values in an isothermal environment.

The present invention is encompassed in the field of assisted reproductive techniques in mammals.

This invention comprises a method in which all the variables of exposure have been verified and optimized. The description also refers an equipment designed for carrying out this process on vessels, cannulas, syringes, test tubes or similar systems used in the steps prior to insemination.

### PRIOR STATE OF THE ART

Sperm viability, vigor and motility describe spermatozoon functionality to suitably move towards the ovule. These factors are directly related with sperm quality and much more decisive in achieving fertilization than the total sperm count. The spermatozoon having insufficient or unsuitable motility does not reach the ovule and this cannot be fertilized naturally.

Spermatozoon migration through the female reproductive tract (internal fertilization) or in synthetic fluids (external fertilization) to reach the ovule is key to successful fertilization. On the other hand, spermatozoon motility is also necessary to go through the extracellular matrices surrounding the ovule.

Spermatozoon motility is activated by specific physiological changes that can vary from one species to another. These changes include, for example, changes in pH, in calcium ion concentration and in specific ligands such as Camp.

Without technological intervention, spermatozoa with low vigor, non-motile or with abnormal motility will not fertilize the ovule; this is one of the main causes of subfertility or infertility.

In artificial insemination methods, semen suspension is introduced into the female reproductive tract. In the scope of infertility treatment in humans, there is a prior capacitation and selection of those spermatozoa with motility which are then introduced directly into the uterus.

Regardless of the type of mammalian spermatozoon to be treated, the object of this patent is to increase spermatozoa motility using non-chemical treatments based on exposure to specific conditions of visible light.

Today, there are different laboratory protocols used for making semen suspension, performing sperm capacitation, and if applicable, selecting cells having suitable motility. Generally, these suspensions are prepared at specific ionic and nutrient concentrations and at a specific pH.

U.S. Pat. No. 5,453,354 discloses a macromolecule of proteinaceous nature which activates sperm motility and the corresponding process for the preparation thereof by means of purifying the macromolecule from extracellular fluids.

U.S. Pat. No. 7,780,230 provides a composition comprising a cytoplasmic extract purified from eggs of Xenopus laevis which is capable of supporting activation of human sperm and complete replication of a human sperm genome.

U.S. Pat. No. 6,309,815 provides a method and a composition for extending the viability of immotile spermatozoa. The method comprises collecting the sperm and treating it with a storage buffer solution to substantially inhibit spermatozoa motility, then storing the semen for a period of time and at a specific temperature and finally reactivating the sperm to normal motility by means of mixing the inhibited spermatozoa with an activation buffer.

On the other hand, the response of ram and fish (tilapia) sperm to different types of light was published in 2005 [1], different types of response being detected depending on the type of sperm and of the type of light. The conclusions made were that the in vitro treatments of mammalian (ram) semen must be performed in the absence of light or under red light, in which a slight increase in motility was detected.

Studies analyzing the response of spermatozoon to visible light in general (the entire spectrum) and the possible cellular mechanisms involved have been published recently [2]. This paper concluded that light radiation for short periods of time caused significant increases in motility, without specifying a specific range of the visible spectrum (it refers to the entire spectrum) or the specific amounts of energy.

The first approach to the activation of mammalian spermatozoa motility with specific wavelengths was performed with dog semen [3, 4] and buffalo semen [5] at 655 nm and 532 nm, respectively. In the first case, a proportional relationship is reported between the type of light and the dose with the motility and in the second case, clear conditions of exposure by means of laser light systems are validated. This last paper suggests the possibility of using laser light as a technique for the in situ improvement of semen quality to optimize the artificial insemination conditions.

Although there is evidence suggesting that phototherapy may be applicable in artificial insemination therapies in mammals, most studies are not more than actions on semen suspensions and only provide confirmation of certain limited increase in motility, but without assessing if other important parameters for determining semen quality are affected and if that actually translates into an increase in the probability of pregnancy in field studies or the way it should be applied at the equipment level in real-life conditions.

U.S. Pat. No. 6,379,939 describes a method for increasing the fertilizing capacity of mammalian, particularly human, sperm cells and it proposes irradiating said sperm cells with light in the extended visible range (300 to 1000 nm) with an intensity of 1 to 1000 mW/cm² wherein the light is not produced by laser and for a period of time between 0.5 and 10 minutes.

Hussein Z M et al. “The effect of diode laser and light emitting diose on the bacterial contamination of semen medium for artificial insemination” discloses a new optical method developed for bacterial growth inhibition in semen containing extender medium using diode laser (DL) and commercial cheap light emitting diode (LED). According to the proposed method samples were immersed in cooled water and exposed to two different light sources, LED and DL for different exposures times that vary from 0 to 20 minutes. The samples were irradiated in integrated distances throughout the straw length. Last steps were repeated with different mechanical frequencies which resulted from cutting the light beam with rotating shutter of both sources. Bacterial counts and semen viability were detected for all exposures in addition to a dark control (extended semen not exposed to light).

It is necessary to provide an alternative to the state of the art which covers the lack of detailed information while at the same time allows working only with optical systems that are not based on laser, having clear operative drawbacks: price and possibility of implementation in in situ work equipment.

### BRIEF DESCRIPTION OF THE INVENTION

In view of the prior art and prior results, the present inventors have focused on the study of phototherapy as a way for improving semen quality, but establishing in situ protocols in human reproduction centers or animal farms. Prior laboratory results have been confirmed for such purpose and in real-life conditions, verifying: light cycles, light dose, time of exposure and devices to perform this treatment on the conventional containers for containing such fluids and under cooling or constant temperature conditions.

This invention describes the conditions for the treatment of mammalian sperm solutions with optical systems that are not based on laser. In this case, a specific range of wavelengths, times of exposure and time of use of the spermatozoa solution in which the motility is maximum are defined, optimum insemination capacity of the spermatozoa being thus assured.

For this purpose, the invention provides in a first aspect a method for increasing the fertilizing capacity of, for example mammalian, sperm cells which, like the known techniques, comprises irradiating said sperm cells with non-coherent red light.

However, the method of the first aspect of the invention is characterized in that the irradiation with non-coherent red light is performed in a discontinuous manner according to a pattern including at least one sequence of two irradiation periods of specific durations which are separated by an intermediate period of darkness of a specific duration which produce very beneficial results for the desired purpose as confirmed by the inventors.

Each of the specific periods of irradiation and darkness can have a duration between 8 and 15 minutes. Said duration is preferably 10 minutes. Furthermore, the mentioned periods of exposure and darkness can have the same or different duration.

On the other hand, the red light can have a wavelength between 620 and 630 nm.

According to one embodiment, at least one semen sample including said sperm cells is diluted in a diluent, and the mentioned irradiation is applied on at least one portion of the diluted sample. Likewise, the at least one portion of the diluted sample or a non-diluted portion of said semen sample can also be introduced in a container having walls transparent to the wavelength of said irradiated red light and the irradiation can be applied on said container. The semen is kept in darkness as a result of the casing of the container.

According to one embodiment, the container is a test tube or microcentrifuge tube and will have a size suitable for the insemination treatment.

The diluted or non-diluted portion of semen sample is preferably kept refrigerated at least until the time immediately before the application of the red light irradiation thereon and/or during said application.

Likewise, the portion or portions of semen sample can be incubated in an isothermal medium at substantially 16-21° C. after being subjected to the mentioned pattern of red light irradiations. Generally, the incubation is performed for different periods, after each of which the method comprises performing analytical controls on the portion or portions of semen sample for determining at least the state of functional viability and motility of the spermatozoa.

The method can be implemented by an apparatus for increasing the fertilizing capacity of, for example mammalian, sperm cells comprising non-coherent red light illumination means configured and arranged for irradiating said sperm cells with non-coherent red light. The referred apparatus configured for implementing the method of the first aspect of the invention, includes:

control means controlling said illumination means for performing said irradiation according to said discontinuous pattern,

a support supporting at least one container of said sperm cells, and the walls of which are transparent to the wavelength of said irradiated red light; and

a casing internally housing said support and the container supported by same and said illumination means arranged for emitting light towards the at least one container.

The apparatus can also include cooling means configured and arranged for cooling the elements housed inside the casing. The control means are preferably programmable at least as regards the pattern (radiation wavelength, focus and duration) of irradiations to be applied.

Once the treatment of the sperm cells has been performed according to the principles of this invention, it has been verified that the percentage of motile spermatozoa and their level of motility improved with respect to their prior baseline level, as has their stress resistance capacity.

Since all the factors which improve the viability and motility of motile spermatozoa are a key factor in a successful ovule fertilization process, this enhancement of cell viability and vigor will increase fertilization probabilities.

### BRIEF DESCRIPTION OF THE DRAWINGS

The foregoing and other advantages and features will be better understood based on the following detailed description of several embodiments in reference to the attached drawings which must be interpreted in an illustrative and non-limiting manner, in which:

FIG. 1 is an example of small samples in 2 ml tubes;

FIG. 2 is an example of diluted samples in 50 ml containers.

### DETAILED DESCRIPTION OF SEVERAL EMBODIMENTS

To confirm the prior evidence and the actual magnitude of phototherapy impact for improving the different descriptive parameters of sperm cell motility-viability and sperm cell resistance to environmental stress (this being considered as 37° C. in times of more than 1 hour), different laboratory studies were conducted using porcine semen as a mammalian model.

Work was performed with porcine spermatozoa because they are a material that can be easily obtained and because they are a good model for extrapolating results to other mammals, including humans.

Work was performed with samples from 15 healthy adult males aged 2-3 and from 5 different breeds (Pietrain, Duroc, Large White, Belgian Landrace and British Landrace). These samples were obtained by means of manual stimulation, immediately diluted in a commercial diluent to a final sperm concentration of 3×10⁷ spermatozoa/ml in a final volume of 90 mL and kept at 16-17° C.

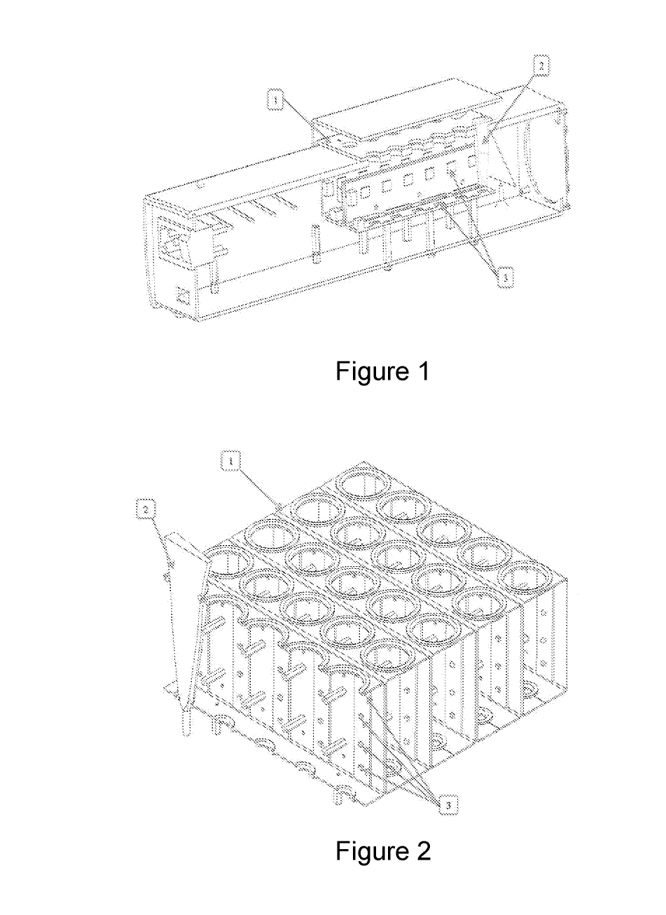

Two aliquots of 1.5 mL were deposited in microcentrifuge tubes, one aliquot was kept in incubation at 16-17° C. as control and the other aliquot was exposed to different photostimulation programs by means of the device described in FIG. 1.

The photostimulation programs implemented are detailed below:
(A) 10 minutes of exposure to red light, 10 minutes of rest and 10 minutes of exposure to red light.
(B) 15 minutes of exposure to red light, 10 minutes of rest and 15 minutes of exposure to red light.
(C) 20 minutes of exposure to red light, 10 minutes of rest and 20 minutes of exposure to red light.

Once the treatment has been performed, both the different control aliquots and the treated aliquots were introduced in a thermostatic bath at 37° C., being incubated for different times (15, 30, 60 and 90 minutes) after which analytical controls were performed for determining the state of functional viability and motility.

The analytical controls were:
1) the estimation of the percentages of viability and of structurally intact acrosomes by means of double staining with Trypan blue/Giemsa [6]
2) Sperm motility analysis by means of computer-aided motility analysis (CASA) measuring the following parameters: curvilinear velocity (VCL), straight-line velocity (VSL), average path velocity (VAP), linearity index (LIN), straightness index (STR), oscillation index (WOB), mean amplitude of lateral head displacement (ALH), mean best cross frequency (BCF).

The results of 5 independent tests were statistically evaluated by means of the log transformation of the data that did not follow normal distribution. Significant differences (p<0.05) were determined by means of the LSMEANS method of the SAS statistics package.

TABLE 1
Experiment 1. Significant differences (*) at 90 minutes between
controls and treatments A, B and C

| | Treatment | | |
|---|---|---|---|
| Test | A | B | C |
| % Viability | * | * | |
| % Altered acrosomes | # | # | |
| % Total motility | * | | * |
| VCL | * | * | * |
| VSL | * | * | |
| VAP | * | * | * |
| LIN | * | * | |
| STR | * | * | * |
| WOB | | * | |
| ALH | | * | * |
| BCF | * | | |

* greater than control
# less than control

These works determined that a dose (time of exposure to the irradiation of non-coherent red light) of excessive duration did not have any effect or the result thereof was not optimum, and that the positive response, in terms of improvement in motility-viability, was strongly related with the combination of at least 2 exposures of non-coherent red light with an intermediate period of darkness of well determined durations in both cases. Generally, treatments A and B showed a clear protective effect, substantially improving sperm survival, the values obtained in treatment A being of a higher level than in treatment B. So treatment A was considered the best from all the treatments evaluated until then and was considered the starting point for application in real-life cases of assisted reproduction in mammals.

For the purpose of verifying if the discontinuous treatment (with an intermediate rest period) had a clear improvement over a treatment that is equivalent but with light dosed in a continuous manner, the following treatment protocols were assessed with the same materials and methods described above.

The photostimulation programs were:

(treatment A again and an unexposed control)
(D) 10 minutes of exposure to red light,
(E) 20 minutes of exposure to red light
(F) 30 minutes of exposure to red light
(G) 45 minutes of exposure to red light

TABLE 2
Experiment 2. Significant differences (*) at 90 minutes between
controls and treatments A, D, E, F and G

| | Treatment | | | | |
|---|---|---|---|---|---|
| Test | A | D | E | F | G |
| % Viability | * | | | | |
| % Altered acrosomes | # | | | | |
| % Total motility | * | | # | # | # |
| VCL | * | * | | | |
| VSL | * | | # | # | # |
| VAP | * | | | | # |
| LIN | * | | # | # | |
| STR | * | | | | |
| WOB | | | | | |
| ALH | | | | | # |
| BCF | * | * | * | * | * |

* greater than control
# less than control

Based on the conclusions of the results shown in Tables 1 and 2, it is deduced that the discontinuous treatments have a substantial improvement over the properties of the mammalian semen (using the semen from different species of pig as a model) and in contrast, a continuous treatment worsens the properties of the semen, these properties being key to fertilization.

It is inferred from the foregoing that controlled photostimulation with non-coherent red LED light, for example at a wavelength of 620-630 nm, in a 10-10-10 (10 minutes of irradiation, followed by 10 minutes of rest and 10 more final minutes of irradiation) pattern of stimulation significantly improve the thermal stress resistance of porcine spermatozoa previously diluted in a commercial diluent cooled at 16-17° C. routinely used in artificial insemination in farms.

This pattern of photostimulation also leads to an improvement in the capacity of these spermatozoa to achieve progesterone-induced in vitro acrosome reaction. These in vitro results suggested that photostimulation has a significant effect on the spermatozoa, improving not only the capacity to resist environmental stress, but also the capacity to penetrate the ovule. Both effects may have, as a whole and as an end result, an improvement in the fertilizing capacity of the photostimulated spermatozoa, with subsequent improvement in the results of in vivo fertility and prolificacy, particularly under conditions in which the environmental stress may reduce said fertility and prolificacy.

An example of application would be in a pig farm where ambient temperature is acting to the detriment of the reproductive capacity.

A second example of application would be in the scope of human reproduction where the lack of motility due to environmental and/or organic causes is related with male infertility.

Since pigs are animals that are metabolically similar to humans and are accepted as models in different fields of medicine, and since the practical demonstration of the second example is ethically unviable without at least having been demonstrated beforehand with an animal model, the validity of this approach in mammals has been verified using pigs as models.

In a study conducted in a breeding farm following the photostimulation method described above with respect to commercial semen doses and using the equipment described above (FIG. 2), 7 different batches of females in heat, in total n=195, were treated by post-cervical insemination. In a manner parallel to each batch of females treated with photostimulated semen suspension (n=78), a second batch was inseminated with untreated suspensions (n=117). The results can be seen in the following table:

TABLE 3
Percentages of fertility for the control group and the group
inseminated with photostimulated commercial doses.

| | | | | Photostimulated |
|---|---|---|---|---|
| | | Control | | semen doses |
| Batch | n | % fertility | n | % fertility |
| 1 | 15 | 93.3 | 13 | 100.0 |
| 2 | 25 | 96.00 | 10 | 100.0 |
| 2 | 18 | 100.00 | 13 | 100.0 |
| 4 | 14 | 92.85 | 13 | 92.3 |
| 4 | 15 | 100.00 | 12 | 100.0 |
| 6 | 16 | 93.33 | 12 | 100.0 |
| 7 | 16 | 93.75 | 11 | 90.91 |
| 8 | 37 | 91.91 | 19 | 94.74 |
| 9 | 19 | 84.23 | 14 | 100 |
| Total | 175 | 93.93 | 117 | 97.55 |

n, number of pregnant females
%, percentage of fertility with respect to the total of the group

The fertility results with a 95% confidence interval are (90.85-97.01)% for the controls and (95.07-100)% for the treated females. A statistical mean comparison test (a one-tailed paired t-test) gives p=0.0448 demonstrating that there are significant differences between the 2 groups despite the higher percentages of fertility in the control group denoting that the study has been conducted in very efficient breeding farms with a high percentage of fertility.

It must be highlighted that once pregnancy ends, a difference of 2 females with positive fertilization in a batch of 100 females is equivalent (with an average of 8 offsprings per individual) to a difference of at least 16 offsprings per batch which has a clear multiplicative effect on the livestock yield.

Data of the number of live births by gestated female with a 95% CI were 13.73 (12.82-14.45) for the control group and 14.31 (13.29-15.33) for those treated with photostimulated semen. These results demonstrate that once pregnant, the use of photostimulated semen does not reduce the prolificacy thereof.

The scope of protection of the invention is defined by the following claims.

### REFERENCES

[1] T. Zan-Bar, B. Bartoov, R. Segal, R. Yehuda, R. Lavi, Dr. R. Lubart, and R. R. Avtalion. Photomedicine and Laser Surgery. 2005, 23(6): 549-555. doi:10.1089/pho.2005.23.549.

[2] Shahar S, Wiser A, Ickowicz D, Lubart R, Shulman A, Breitbart H. Hum. Reprod. (2011) 26 (9): 2274-2282. doi: 10.1093/humrep/der232

[3] Corral-Baqués M I, Rivera M M, Rigau T, Rodríguez-Gil J E, Rigau J. Lasers Med Sci. 2009 September; 24(5):703-13.

[4] Corral-Baqués M I, Rigau T, Rivera M, Rodríguez J E, Rigau J. Lasers Med Sci. 2005; 20(1):28-34

[5] Abdel-Salam Z, Dessouki S H, Abdel-Salam S A, Ibrahim M A, Harith M A. Theriogenology. 2011 Apr. 1; 75(6):988-94.

[6] Rodríguez-Gil, J. E. and Rigau, T 1995 An. Rep. Sci., 39: 141-146.

1. A method for increasing the fertilizing capacity of sperm cells, comprising:
irradiating said sperm cells with non-coherent red light, wherein said irradiation is performed in a discontinuous manner with non-coherent red light according to a pattern including at least one sequence of two periods of sperm cell irradiation of a specific duration which are separated by an intermediate period of darkness of a specific duration and in that each of said specific periods of irradiation and darkness has a duration between 8 and 15 minutes.

2. A method according to claim 1, wherein the duration of said two periods of irradiation and of the intermediate period of darkness is the same.

3. The method according to claim 1, wherein each of said specific periods of irradiation and darkness has a duration of 10 minutes, and the duration of said two periods of irradiation and of the intermediate period of darkness is the same.

4. The method according to the claim 1, wherein said periods of irradiation and darkness are of different duration.

5. The method according to claim 1, wherein said red light has a wavelength between 620 and 630 nm.

6. The method according to claim 1, further comprising:
diluting in a diluent at least one semen sample including said sperm cells, and applying said irradiation on at least one portion of said diluted sample.

7. The method according to claim 6, further comprising:
introducing said at least one portion or a non-diluted portion of said semen sample in a container having walls transparent to the wavelength of said irradiated red light and applying said irradiation on said container.

8. The method according to claim 7, wherein said container is a test tube or microcentrifuge tube having a suitable size for human or animal reproduction.

9. The method according to claim 8, further comprising:
keeping said at least one diluted or non-diluted portion of semen sample refrigerated at least until the time immediately before the application of the red light irradiation thereon and/or during said application.

10. The method according to claim 9, further comprising:
incubating in an isothermal medium at substantially 16-21° C. the portion or portions of semen sample after being subjected to said pattern of red light irradiations.

11. The method according to claim 10, further comprising:
performing said incubation for different periods, after each of which the method comprises performing analytical controls on the portion or portions of semen sample for determining at least the state of functional viability and motility of the spermatozoa.

12. The method according to claim 1, wherein said sperm cells are mammalian sperm cells.
